(19) United States
(12) Patent Application Publication
(10) Pub. No.: US 2005/0259411 A1
(43) Pub. Date: Nov. 24, 2005

(54) Key with light emitting key insertion portion

(76) Inventors: Chang Hao Chen, Tau Yuan City (TW); Wu Chun Hsu, Tau Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/851,120

(22) Filed: May 24, 2004

(51) Int. Cl. F21L 4/04; F21V 9/16

(52) U.S. Cl. 362/116; 362/84; 362/200

(57) ABSTRACT

A key with a light emitting key insertion portion comprises a key insertion portion including a hollow metal case and an light emitting source installed within the hollow metal case; the hollow metal case being hollowed and having two openings at two ends; a light emitting source including a rubber body, a light stimulating metal and two conductive wires; the key insertion portion has a shape with a plurality of grooves so that a front end of the light emitting source protrudes from the front end of the hollow metal case and parts of the light emitting source protruding from the grooves; and a handle having a power source unit; the key insertion portion being assembled to the handle. The power source unit includes an LED lamp, a circuit board, a battery cell, and a switch; and the two conductive wires of the light emitting source are connected to the power source unit.

### FIELD OF THE INVENTION

The present invention relates to keys, and particular to a key with a light emitting key insertion portion so that the key hole has sufficient light to radiate thereon and the key can present beautiful light effect.

### BACKGROUND OF THE INVENTION

A key is formed by a key insertion portion and a handle connected to the key insertion portion. With reference to FIG. 1, a key insertion portion 1 having a plurality of grooves 2 is connected to a handle 3. A power source unit 10 is installed in the handle 3. The power source unit 10 has a circuit board 11 having a mercury cell 12, a switch 13 and a round LED lamp 14. The LED lamp 14 protrudes from the handle 3 so as to control the turning on and off of the LED lamp 14 to achieve the effect of illumination.

However, the prior art has the following defects. The key insertion portion is a solid metal plate. No light radiates from the key insertion portion. The LED lamp 14 has a distance from the key insertion portion 1 so that light cannot radiate to the key insertion portion. Thus, the key hole has no sufficient light to radiate thereon.

### SUMMARY OF THE INVENTION

Accordingly, the primary object of the present invention is to provide a key with a light emitting key insertion portion, wherein the key hole has sufficient light to radiate thereon and the key can present beautiful light effect.

To achieve above objects, the present invention provides a key with a light emitting key insertion portion which comprises a key insertion portion including a hollow metal case and an light emitting source installed within the hollow metal case; the hollow metal case being hollowed and having two openings at two ends; a light emitting source including a rubber body, a light stimulating metal and two conductive wires; the key insertion portion has a shape with a plurality of grooves so that a front end of the light emitting source protrudes from the front end of the hollow metal case and parts of the light emitting source protruding from the grooves; and a handle having a power source unit; the key insertion portion being assembled to the handle. Power source unit includes an LED lamp, a circuit board, a battery cell, and a switch; and the two conductive wires of the light emitting source are connected to the power source unit.

The various objects and advantages of the present invention will be more readily understood from the following detailed description when read in conjunction with the appended drawing.

### BRIEF DESCRIPTION OF THE DRAWINGS

FIG. 1 shows a prior art structure about the light emitting key.

FIG. 2 is an exploded perspective view of the present invention.

FIG. 3A is a perspective view of an unfinished key of the present invention.

FIG. 3B is a perspective view of a finished key of the present invention.

FIG. 4A is a cross section view of an unfinished key of the present invention.

FIG. 4B is a cross section view of a finished key of the present invention.

FIG. 4C is a front view of the key of the present invention.

FIG. 5A is a front view of another embodiment of the present invention.

FIG. 5B is a lateral view of the embodiment of FIG. 5A.

FIG. 6 is a perspective view showing that the present invention is assembled to a remote controller.

FIG. 7A is an exploded perspective view of a further embodiment of the present invention.

FIG. 7B is a front cross section view of the embodiment illustrated in FIG. 7A.

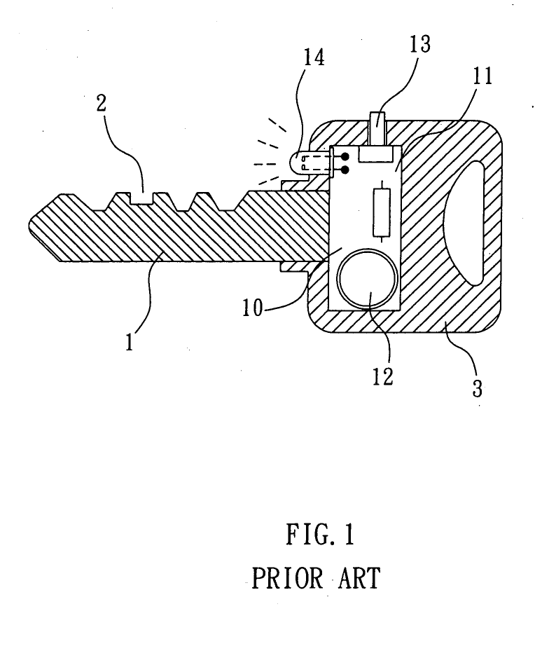

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

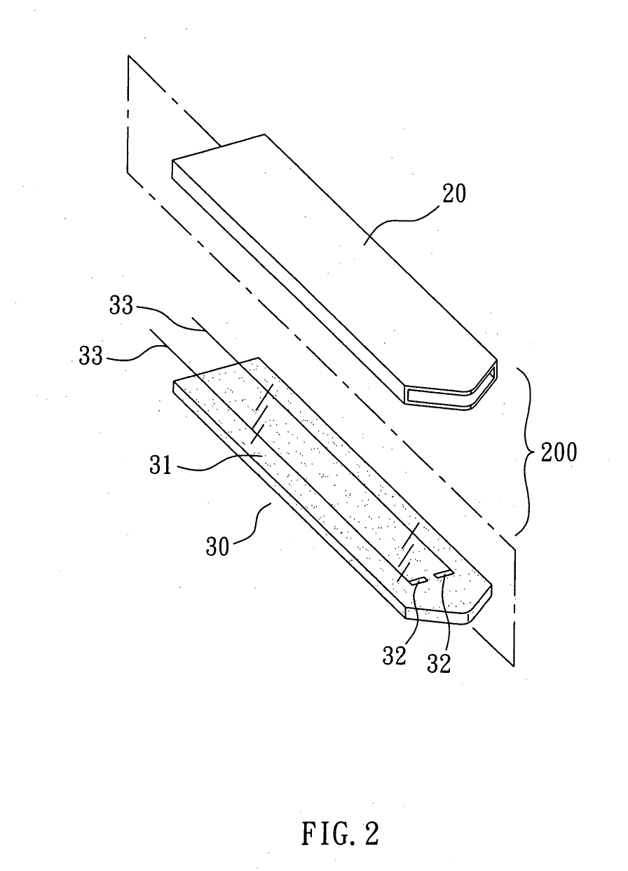

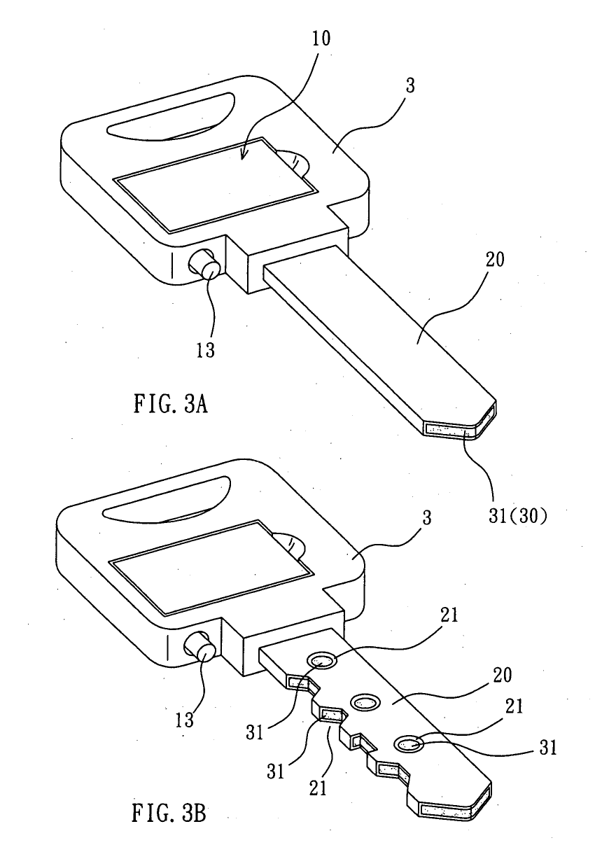

With reference to FIGS. 2 to 7, the light emitting key insertion portion of the present invention includes the following elements.

A key insertion portion 200 is formed by a hollow metal case 20 and a light emitting source is installed within the hollow metal case 20. The hollow metal case 20 is hollowed and has two openings at two ends. The light emitting source 30 includes a rubber body 31, a light stimulating metal 32 and two conductive wires 33. The key insertion portion 200 is lathed to a desired shape with a plurality of grooves 21 so that a front end of the light emitting source 30 protrudes from the front end of the hollow metal case 20 and parts of the light emitting source 30 protrude from the grooves 21.

A handle 3 has a power source unit 10. The key insertion portion 200 is assembled to the handle 3. The power source unit 10 includes an LED lamp 14, a circuit board 11, a battery cell 12, and a switch 13. The two conductive wires 33 of the light emitting source 30 are connected to the power source unit 10.

When power is turned on, the light emitting source 30 lights up so that the front end and grooves 21 radiate light. Thereby, the key insertion portion 200 has light effect instead of that the handle 3 radiates light. Thereby, the light can radiate to a keyhole. Thus, the light emitted from the key insertion portion 200 will present a special light effect so that the key has a beautiful outlook.

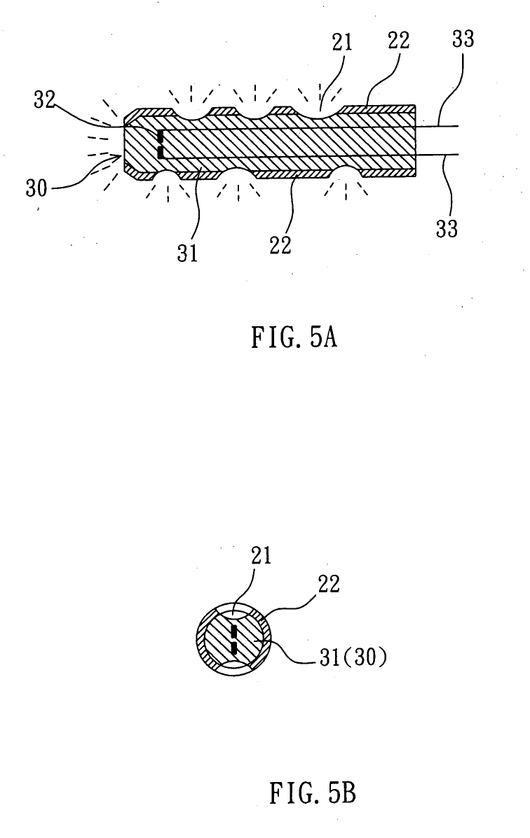

With reference to FIGS. 5A and 5B, in this embodiment, the handle 3 is a round cylindrical metal casing 22 and the light emitting source 30 has a shape corresponding to the shape of the round cylindrical metal casing 22.

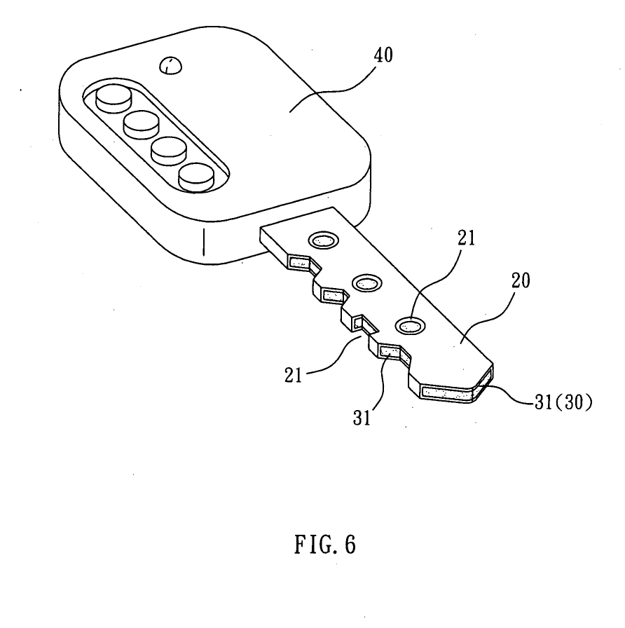

With reference to FIG. 6, in this embodiment, the key insertion portion 200 is assembled to a remote controller 40 and the light source of the key insertion portion 200 is from the remote controller 40.

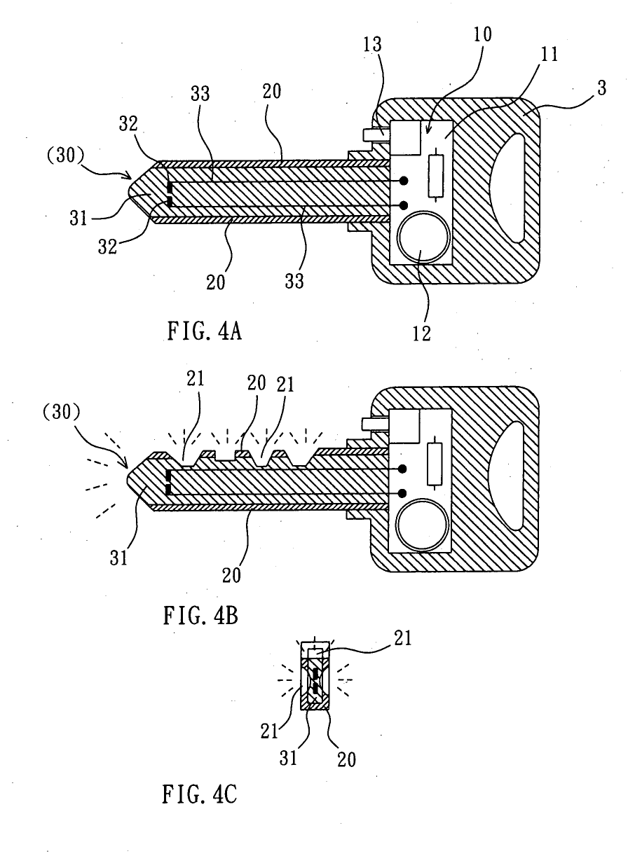

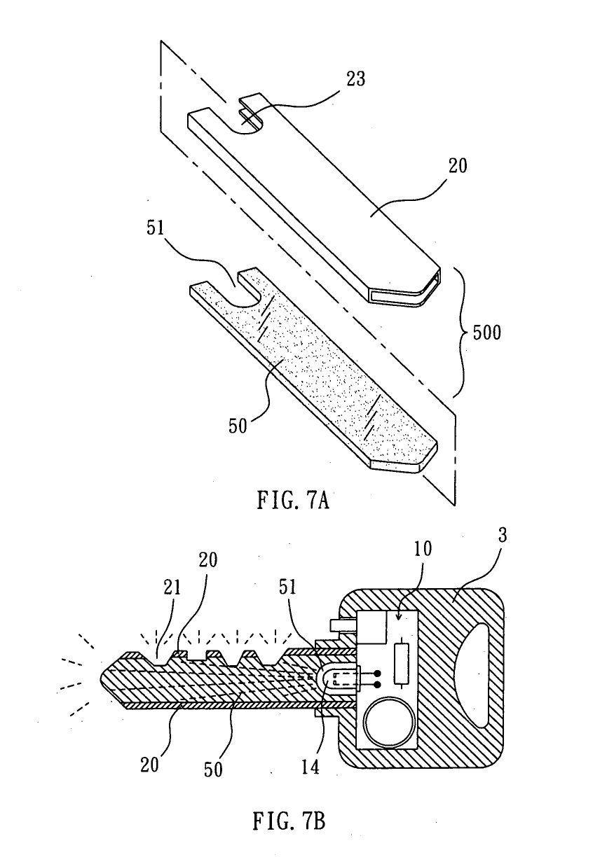

With reference to FIGS. 7A and 7B, in this embodiment, the key insertion portion 500 has a hollow metal case 20 and a light emitting source 50. The hollow metal case 20 has a groove 23 at one end thereof near the handle 3 and the light emitting source 50 has a groove 51 corresponding to the groove 23 of the hollow metal case 20. In assembly, the groove of the hollow metal case 20 is aligned to the groove 51 of the light emitting source 50 and the LED lamp 14 is installed in the grooves 23 and 51. The other portions of this embodiment are identical to those illustrated in FIG. 4.

Moreover, the rubber in the rubber body 31 is mixed with fluorescent material so that the rubber body has a fluorescent effect.

In above embodiments, the LED lamp 14 and light emitting source 30 are not used to confine the scope of the present invention. Other light sources are suitable. For example, the light emitting source is a laser light emitter or at least one light emitting diodes.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A key with a light emitting key insertion portion comprising:
a key insertion portion including a hollow metal case and an light emitting source installed within the hollow metal case; the hollow metal case being hollowed and having two openings at two ends; a light emitting source including a rubber body, a light stimulating metal and two conductive wires; the key insertion portion has a shape with a plurality of grooves so that a front end of the light emitting source protrudes from the front end of the hollow metal case and parts of the light emitting source protruding from the grooves; and
a handle having a power source unit; the key insertion portion being assembled to the handle.

2. The key with a light emitting key insertion portion as claimed in claim 1, wherein power source unit includes an LED lamp, a circuit board, a battery cell, and a switch; and the two conductive wires of the light emitting source are connected to the power source unit.

3. The key with a light emitting key insertion portion as claimed in claim 1, wherein the hollow metal case and the light emitting source have plate-like shape.

4. The key with a light emitting key insertion portion as claimed in claim 1, wherein the hollow metal case and light emitting source have round shape.

5. The key with a light emitting key insertion portion as claimed in claim 1, wherein the hollow metal case has a groove at one end thereof near the handle and the light emitting source has a groove corresponding to the groove of the hollow metal case; the groove of the hollow metal case is aligned to the groove of the light emitting source and the LED lamp is installed in the grooves.

6. The key with a light emitting key insertion portion as claimed in claim 1, wherein the light emitting source is formed by at least one light emitting diode.

7. The key with a light emitting key insertion portion as claimed in claim 1, wherein the light emitting source is a laser light emitter.

8. The key with a light emitting key insertion portion as claimed in claim 1, wherein the rubber in the rubber body is mixed with fluorescent material so that the rubber body has a fluorescent effect.
